(19) United States
(12) Patent Application Publication
(10) Pub. No.: US 2021/0304700 A1
(43) Pub. Date: Sep. 30, 2021

(54) CONTROL METHOD FOR DISPLAY DEVICE AND DISPLAY DEVICE

(71) Applicant: SEIKO EPSON CORPORATION, Tokyo (JP)

(72) Inventor: Toshiki FUJIMORI, Chino-shi (JP)

(21) Appl. No.: 17/213,351

(22) Filed: Mar. 26, 2021

(30) Foreign Application Priority Data
Mar. 27, 2020 (JP) 2020-057354

(51) Int. Cl. G09G 5/00; G06F 3/16

(52) U.S. Cl. CPC G09G 5/006; G06F 3/165; G09G 2320/0626; G09G 2320/0666; G06F 3/167

(57) ABSTRACT

A control method for a projector that includes a microphone accepting a speech-based operation and a remote control light receiving unit or an operation panel accepting a non-speech-based operation is provided. When the microphone accepts a speech-based operation, a first operation mode is executed and a first setting UI showing that processing corresponding to the speech-based operation is executed is displayed. When the remote control light receiving unit or the operation panel accepts a non-speech-based operation, a second operation mode is executed and a second setting UI that can be operated by a non-speech-based operation accepted by the remote control light receiving unit or the operation panel is displayed. The processing corresponding to the speech-based operation accepted by the microphone is not executed while the second setting UI is being displayed.

The present application is based on, and claims priority from JP Application Serial Number 2020-057354, filed Mar. 27, 2020, the disclosure of which is hereby incorporated by reference herein in its entirety.

### BACKGROUND

### 1. Technical Field

The present disclosure relates to a control method for a display device and a display device.

### 2. Related Art

According to the related art, a display device that can perform an operation based on a speech is known. For example, JP-A-2001-216131 discloses a technique in which a computer recognizing a speech and executing predetermined processing corresponding to the recognized speech displays a window showing a state where speech recognition is indicated near an application for transmitting the result of the recognition of the speech.

If the display device as disclosed in JP-A-2001-216131 can only perform an operation based on a speech, a user may not be able to satisfactorily operate the display device. Therefore, it is desired that such a display device can also perform an operation based on a non-speech measure. However, when the user operates the display device via a non-speech measure, processing not intended by the user may be executed based on a speech. Also, in the case of JP-A-2001-216131, the display content may change to a content not intended by the user. Therefore, it is difficult to enable the display device as disclosed in JP-A-2001-216131 to perform both an operation based on a speech and an operation based on a non-speech measure.

### SUMMARY

In order to solve the foregoing problem, an aspect of the present disclosure is directed to a control method for a display device that includes a first acceptance unit accepting a first operation based on a speech and a second acceptance unit accepting a second operation based on a non-speech measure. The control method includes: executing a first operation mode when the first acceptance unit accepts the first operation, and displaying a first user interface showing that processing corresponding to the first operation is executed; executing a second operation mode when the second acceptance unit accepts the second operation, and displaying a second user interface that can be operated by the second operation accepted by the second acceptance unit; and not executing the processing corresponding to the first operation accepted by the first acceptance unit, while displaying the second user interface.

In order to solve the foregoing problem, to another aspect of the present disclosure is directed to a display device including: a display unit; a first acceptance unit accepting a first operation based on a speech; a second acceptance unit accepting a second operation based on a non-speech measure; and a control unit executing a first operation mode when the first acceptance unit accepts the first operation, and displaying a first user interface showing that processing corresponding to the first operation is executed, the control unit executing a second operation mode when the second acceptance unit accepts the second operation, and displaying a second user interface that can be operated by the second operation accepted by the second acceptance unit. The control unit does not execute the processing corresponding to the first operation accepted by the first acceptance unit, while the second user interface is being displayed.

### BRIEF DESCRIPTION OF THE DRAWINGS

FIG. 1 is a block diagram showing the configuration of a projector.

FIG. 2 is a flowchart showing operations of the projector.

FIG. 3 shows an example of a first setting UI.

FIG. 4 shows an example of the first setting UI.

FIG. 5 shows an example of a second setting UI.

FIG. 6 shows an example of the second setting UI.

### DESCRIPTION OF EXEMPLARY EMBODIMENTS

### First Embodiment

A first embodiment will be described.

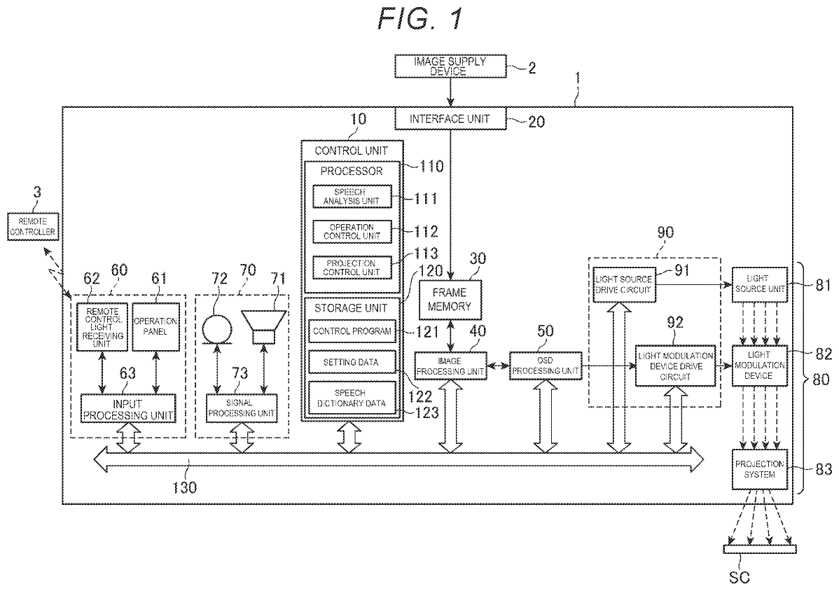

FIG. 1 is a block diagram showing the configuration of a projector 1. The projector 1 is equivalent to an example of a display device.

An image supply device 2 as an external device is coupled to the projector 1. The image supply device 2 outputs image data to the projector 1. The projector 1 projects an image onto a screen SC as a projection surface, based on the image data inputted from the image supply device 2. The projecting is equivalent to an example of displaying.

The image data inputted from the image supply device 2 is image data conforming to a predetermined standard. This image data may be still image data or video image data and may be accompanied by audio data.

The image supply device 2 is a so-called image source outputting image data to the projector 1. The image supply device 2 is not limited to any specific configuration and may be any device that can be coupled to the projector 1 and that can output image data to the projector 1. For example, a disc-type recording medium playback device, television tuner device, personal computer, document camera or the like may be used as the image supply device 2.

The screen SC may be a curtain-like screen. Alternatively, a wall surface of a building or a planar surface of an installation may be used as the screen SC. The screen SC is not limited to a planar surface and may be a curved surface or concave/convex surface.

The projector 1 has a control unit 10.

The control unit 10 has a processor 110 executing a program, such as a CPU or MPU, and a storage unit 120, and controls each part of the projector 1. The control unit 10 executes various kinds of processing via a cooperation of hardware and software in such a way that the processor 110 reads out a control program 121 stored in the storage unit 120 and executes processing. As the processor 110 reads out and executes the control program 121, the control unit 10 functions as a speech analysis unit 111, an operation control unit 112, and a projection control unit 113. Details of these functional blocks will be described later.

The storage unit 120 has a storage area storing a program executed by the processor 110 and data processed by the processor 110. The storage unit 120 has a non-volatile storage area storing a program and data in a non-volatile manner. The storage unit 120 may also have a volatile storage area that forms a work area for temporarily storing a program executed by the processor 110 and data to be processed.

The storage unit 120 also stores setting data 122 and speech dictionary data 123 as well as the control program 121 executed by the processor 110. The setting data 122 includes a setting value about an operation of the projector 1. The setting value included in the setting data 122 is, for example, a setting value indicating a volume level of a sound outputted from a speaker 71, a setting value indicating a color mode for adjusting the hue and brightness of a projection image according to the purpose of viewing or the like, a setting value indicating a content of processing executed by an image processing unit 40 and an OSD processing unit 50, and a parameter used for processing by the image processing unit 40 and the OSD processing unit 50, or the like. The speech dictionary data 123 is data for the control unit 10 to analyze a user's speech picked up by a microphone 72. For example, the speech dictionary data 123 includes dictionary data for converting digital data of a user's speech into a text in Japanese, English or other set languages.

The projector 1 has an interface unit 20, a frame memory 30, the image processing unit 40, the OSD processing unit 50, an operation unit 60, and an audio processing unit 70. These units are coupled in such a way as to be able to communicate with the control unit 10 via a bus 130.

The interface unit 20 has communication hardware such as a connector and an interface circuit conforming to a predetermined communication standard. In FIG. 1, the illustration of the connector and the interface circuit is omitted. The interface unit 20 transmits and receives image data and control data or the like to and from the image supply device 2, under the control of the control unit 10 and according to the predetermined communication standard. As the interface of the interface unit 20, for example, an interface that can digitally transmit a video signal and an audio signal, such as an HDMI (High-Definition Multimedia Interface), DisplayPort, HDBaseT, USB, Type-C, or 3G-SDI (serial digital interface), can be used. HDMI is a registered trademark. HDBaseT is a registered trademark. Also, as the interface, an interface for data communication such as Ethernet, IEEE 1394, or USB can be used. Ethernet is a registered trademark. Also, as the interface, an interface having an analog video terminal such as an RCA terminal, VGA terminal, S terminal or D terminal and configured to be able to transmit and receive an analog video signal can be used.

The frame memory 30, the image processing unit 40, and the OSD processing unit 50 are formed, for example, of an integrated circuit. The integrated circuit includes an LSI, ASIC (application-specific integrated circuit), PLD (programmable logic device), FPGA (field-programmable gate array), and SoC (system-on-a-chip) or the like. A part of the configuration of the integrated circuit may include an analog circuit. The control unit 10 and the integrated circuit may be combined together.

The frame memory 30 has a plurality of banks. Each band has a storage capacity to store one frame of image data can be written. The frame memory 30 is formed, for example, of an SDRAM. SDRAM is an abbreviation of synchronous dynamic random-access memory.

The image processing unit 40 performs image processing on image data loaded in the frame memory 30, for example, resolution conversion processing, resizing processing, correction of distortion aberration, shape correction processing, digital zoom processing, adjustment of the color tone and brightness of the image, or the like. The image processing unit 40 executes processing designated by the control unit 10 and performs processing using a parameter inputted from the control unit 10 according to need. The image processing unit 40 can also execute a combination of a plurality of kinds of image processing of the above.

The image processing unit 40 reads out the processed image data from the frame memory 30 and outputs the image data to the OSD processing unit 50.

The OSD processing unit 50, under the control of the control unit 10, performs processing to superimpose a user interface according to the setting of the projector 1 onto an image represented by the image data inputted from the image processing unit 40. In the description below, this user interface is referred to as a “setting UI” denoted by a numeral “140”. The setting of the projector 1 is equivalent to an example of processing corresponding a first operation and a second operation.

The OSD processing unit 50 has an OSD memory, not illustrated, and stores information representing a geometric shape, font and the like to form the setting UI 140. When the control unit 10 gives an instruction to superimpose the setting UI 140, the OSD processing unit 50 reads out necessary information from the OSD memory and generates forming data to form the designated setting UI 140. The OSD processing unit 50 then combines the generated forming data with the image data inputted from the image processing unit 40 in such a way that the setting UI 140 is superimposed at a predetermined position on the image represented by the image data inputted from the image processing unit 40. The combined image data with the forming data combined is outputted to a light modulation device drive circuit 92. Meanwhile, when there is no instruction from the control unit 10 to superimpose the setting UI 140, the OSD processing unit 50 outputs the image data inputted from the image processing unit 40 directly to the light modulation device drive circuit 92 without processing.

The operation unit 60 has an operation panel 61, a remote control light receiving unit 62, and an input processing unit 63. The operation panel 61 and the remote control light receiving unit 62 are equivalent to an example of a second acceptance unit.

The operation panel 61 is provided on the casing of the projector 1 and has various switches that are operable by the user. The input processing unit 63 detects an operation of each switch on the operation panel 61.

The remote control light receiving unit 62 receives an infrared signal transmitted from a remote controller 3. The input processing unit 63 decodes the signal received by the remote control light receiving unit 62, thus generates operation data, and outputs the operation data to the control unit 10.

The input processing unit 63 is coupled to the operation panel 61 and the remote control light receiving unit 62. When the operation panel 61 or the remote control light receiving unit 62 accepts a user operation, the input processing unit 63 generates operation data corresponding to the accepted operation and outputs the operation data to the control unit 10.

The audio processing unit 70 has the speaker 71, the microphone 72, and a signal processing unit 73. The microphone 72 is equivalent to an example of a first acceptance unit.

When a digital audio signal is inputted to the signal processing unit 73 from the control unit 10, the signal processing unit 73 converts the inputted audio signal from digital to analog. The signal processing unit 73 outputs the converted analog audio signal to the speaker 71. The speaker 71 outputs a sound based on the inputted audio signal.

When the microphone 72 picks up a sound, an analog audio signal representing the sound picked up by the microphone 72 is inputted to the signal processing unit 73. The signal processing unit 73 converts the audio signal inputted from the microphone 72 from analog to digital and outputs the converted digital audio signal to the control unit 10.

The projector 1 has a projection unit 80 and a drive unit 90 driving the projection unit 80. The projection unit 80 is equivalent to an example of a display unit.

The projection unit 80 has a light source unit 81, a light modulation device 82, and a projection system 83. The drive unit 90 has a light source drive circuit 91 and the light modulation device drive circuit 92.

The light source drive circuit 91 is coupled to the control unit 10 via the bus 130 and is also coupled to the light source unit 81. The light source drive circuit 91 turns on or off the light source unit 81, under the control of the control unit 10.

The light modulation device drive circuit 92 is coupled to the control unit 10 via the bus 130 and is also coupled to the light modulation device 82. The light modulation device drive circuit 92, under the control of the control unit 10, drives the light modulation device 82 and draws an image on a frame basis at a light modulation element provided in the light modulation device 82. The light modulation device drive circuit 92 receives image data corresponding to the primary colors of R, G, and B inputted from the image processing unit 40. The light modulation device drive circuit 92 converts the inputted image data to a data signal suitable for the operation of a liquid crystal panel that is the light modulation element provided in the light modulation device 82. The light modulation device drive circuit 92 applies a voltage to each pixel in each liquid crystal panel, based on the converted data signal, and thus draws an image on each liquid crystal panel.

The light source unit 81 is formed of a lamp such as a halogen lamp, xenon lamp, or ultra-high-pressure mercury lamp, or a solid-state light source such as an LED or laser light source. The light source unit 81 turns on with electric power supplied from the light source drive circuit 91 and emits light toward the light modulation device 82.

The light modulation device 82 has, for example, three liquid crystal panels corresponding to the primary colors of R, G, and B. R represents red. G represents green. B represents blue. The light emitted from the light source unit 81 is separated into color light of three colors of R, G, and B, which then becomes incident on the corresponding liquid crystal panels. Each of the three liquid crystal panels is a transmission-type liquid crystal panel, which modulates the transmitted light and thus generates image light. The image light modulated bypassing through each liquid crystal panel is combined together by a light combining system such as a cross dichroic prism and is emitted to the projection system 83.

In this embodiment, an example case where the light modulation device 82 has transmission-type liquid crystal panels as light modulation elements is described. However, the light modulation element may be a reflection-type liquid crystal panel or a digital micromirror device.

The projection system 83 has a lens, a mirror, and the like for causing the image light modulated by the light modulation device 82 to form an image on the screen SC. The projection system 83 may have a zoom mechanism for enlarging or reducing the image projected on the screen SC, a focus adjustment mechanism for adjusting the focus, and the like.

The functional blocks of the control unit 10 will now be described.

The speech analysis unit 111 performs speech recognition processing of analyzing a digital signal of a speech picked up by the microphone 72 with reference to the speech dictionary data 123 stored in the storage unit 120 and forming a text of the speech picked up by the microphone 72. The speech analysis unit 111 outputs speech text data, which is data of the text of the speech picked upby the microphone 72, to the operation control unit 112.

The operation control unit 112 in this embodiment has a first operation mode and a second operation mode, as its operation modes. The first operation mode is a mode where the projector 1 is set to correspond to a speech-based operation, which is an operation based on a speech. The second operation mode is a mode where the projector 1 is set to correspond to a non-speech-based operation, which is an operation based on a non-speech measure. In this embodiment, an example of the non-speech-based operation is an operation via the remote controller 3 or an operation via the operation panel 61. The speech-based operation is equivalent to an example of a first operation. The non-speech-based operation is equivalent to an example of a second operation.

When speech text data is inputted to the operation control unit 112 from the speech analysis unit 111, the operation control unit 112 executes the first operation mode. Based on the speech text data inputted from the speech analysis unit 111, the operation control unit 112 specifies a target of setting and a content of setting represented by the speech text data. For example, the operation control unit 112 performs letter string search through the speech text data and specifies the target of setting and the content of setting represented by the speech text data.

For example, when speech text data of “volume, higher” is inputted, the operation control unit 112 specifies the volume as the target of setting represented by the speech text data and specifies setting the volume higher as the content of setting represented by the speech text data.

Also, for example, when speech text data of “color mode, dynamic” is inputted, the operation control unit 112 specifies the color mode as the target of setting represented by the speech text data and specifies setting the color mode to a dynamic mode as the content of setting represented by the speech text data. The dynamic mode is a color mode suitable for viewing in a bright place under a fluorescent lamp.

On specifying the target of setting and the content of setting represented by the speech text data, the operation control unit 112 executes a setting of the projector 1 corresponding to the target of setting and the content of setting that are specified. The operation control unit 112 then outputs a setting result notification reporting the result of the setting to the projection control unit 113.

For example, it is assumed that the operation control unit 112 specifies the volume as the target of setting represented by the speech text data and specifies setting the volume higher as the content of setting represented by the speech text data. In this case, the operation control unit 112 updates the set value of the volume level in the setting data 122 and thus sets the volume level of a sound outputted from the speaker 71 to a higher level than the current volume level. For example, when the set value of the volume level in the setting data 122 is “10”, the operation control unit 112 updates the set value of the volume level to “15”. In this embodiment, a greater numeric value of the volume level represents a higher volume. In this case, the operation control unit 112 outputs a setting result notification reporting that the volume level is set to “15”, to the projection control unit 113.

Also, for example, it is assumed that when the speech text data of “color mode, dynamic” is inputted, the operation control unit 112 specifies the color mode as the target of setting represented by the speech text data and specifies setting the color mode to the dynamic mode as the content of setting represented by the speech text data. In this case, the operation control unit 112 updates the set value of the color mode in the setting data 122 to a set value indicating the dynamic mode and thus sets the color mode to the dynamic mode. In this case, the operation control unit 112 outputs a setting result notification reporting that the color mode is set to the dynamic mode, to the projection control unit 113.

When operation data is inputted to the operation control unit 112 from the input processing unit 63, the operation control unit 112 executes the second operation mode. In the second operation mode, the operation control unit 112 executes a setting of the projector 1 according to the operation data inputted from the input processing unit 63. In the second operation mode, even when speech text data is inputted from the speech analysis unit 111, the operation control unit 112 does not execute a setting of the projector 1 corresponding a speech-based operation. That is, in the second operation mode, the operation control unit 112 does not execute a setting of the projector 1 corresponding to a speech-based operation accepted by the microphone 72. On starting the execution of the second operation mode, the operation control unit 112 outputs a second operation mode notification reporting that the operation mode is the second operation mode, to the projection control unit 113.

The projection control unit 113 controls the image processing unit 40, the OSD processing unit 50, the drive unit 90 and the like to project an image onto the screen SC.

Specifically, the projection control unit 113 controls the image processing unit 40 and causes the image processing unit 40 to process image data loaded in the frame memory 30. At this time, the projection control unit 113 reads out a parameter that is necessary for the image processing unit 40 to perform processing, from the storage unit 120, and outputs the parameter to the image processing unit 40.

The projection control unit 113 also controls the OSD processing unit 50 and causes the OSD processing unit 50 process the image data inputted from the image processing unit 40. When a setting result notification is inputted to the projection control unit 113 from the operation control unit 112, the projection control unit 113 causes the OSD processing unit 50 to perform processing to superimpose a first setting UI 1010. The first setting UI 1010 is a setting UI 1000 showing that a setting of the projector 1 corresponding to a speech-based operation is executed. The first setting UI 1010 is equivalent to an example of a first user interface.

When a second operation mode notification is inputted to the projection control unit 113 from the operation control unit 112, the projection control unit 113 causes the OSD processing unit 50 to perform processing to superimpose a second setting UI 1020. The second setting UI 1020 is a setting UI 1000 for executing a setting of the projector 1 corresponding to a non-speech-based operation. The second setting UI 1020 is equivalent to an example of a second user interface.

The projection control unit 113 controls the light source drive circuit 91 and the light modulation device drive circuit 92, causes the light source drive circuit 91 to turn on the light source unit 81, causes the light modulation device drive circuit 92 to drive the light modulation device 82, and thus causes the projection unit 80 to project image light and display an image on the screen SC. The projection control unit 113 also controls the projection system 83 to start its motor and adjusts the zoom and focus of the projection system 83.

Operations of the projector 1 will now be described.

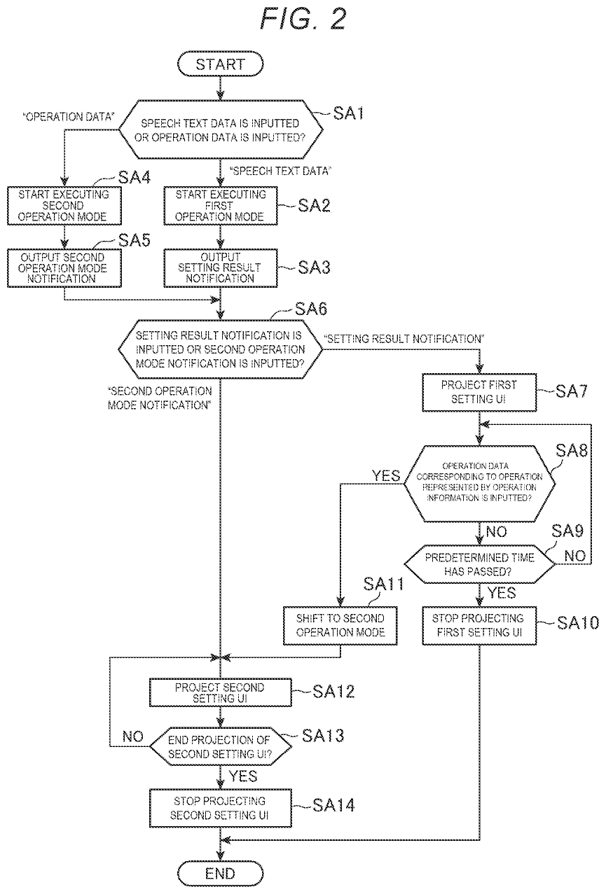

FIG. 2 is a flowchart showing operations of the projector 1.

The operation control unit 112 of the projector 1 determines whether speech text data is inputted from the speech analysis unit 111 or operation data is inputted from the input processing unit 63 (step SA1).

When it is determined that speech text data is inputted from the speech analysis unit 111 (speech text data in step SA1), the operation control unit 112 starts executing the first operation mode (step SA2).

Next, the operation control unit 112 executes a setting of the projector 1 corresponding to the target of setting and the content of setting represented by the speech text data and outputs a setting result notification to the projection control unit 113 (step SA3).

For example, it is assumed that the operation control unit 112 specifies the volume as the target of setting represented by the speech text data and specifies setting the volume higher as the content of setting represented by the speech text data. In this case, the operation control unit 112 sets the volume of a sound outputted from the speaker 71 to be higher than the current volume, and outputs a setting result notification indicating the set volume level to the projection control unit 113.

Also, for example, it is assumed that when speech text data of “color mode, dynamic” is inputted, the operation control unit 112 specifies the color mode as the target of setting represented by the speech text data and specifies setting the color mode to the dynamic mode as the content of setting represented by the speech text data. In this case, the operation control unit 112 sets the color mode to the dynamic mode and outputs a setting result notification indicating that the set color mode is the dynamic mode, to the projection control unit 113.

Back to the description of step SA1, when it is determined that operation data is inputted from the input processing unit 63 (operation data in step SA1), the operation control unit 112 starts executing the second operation mode (step SA4).

Next, the operation control unit 112 outputs a second operation mode notification to the projection control unit 113 (step SA5).

The projection control unit 113 determines whether the notification inputted from the operation control unit 112 is a setting result notification or a second operation mode notification (step SA6).

When it is determined that the notification inputted from the operation control unit 112 is a setting result notification (setting result notification in step SA6), the projection control unit 113 causes the projection unit 80 to project the first setting UI 1010 (step SA7).

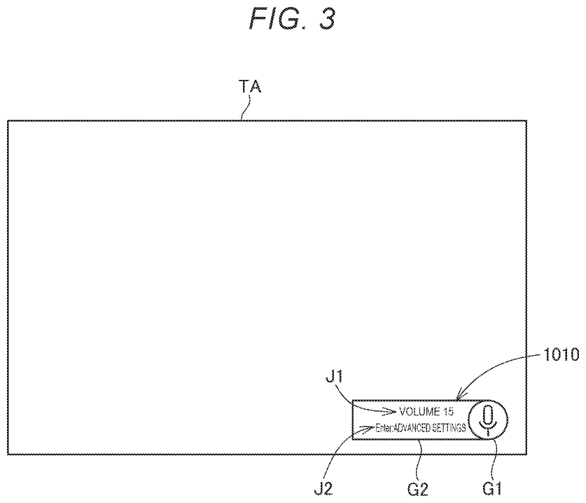

FIG. 3 shows an example of the first setting UI 1010.

The first setting UI 1010 shown in FIG. 3 shows that the volume level is set to “15” by a speech-based operation. In FIG. 3, the first setting UI 1010 is projected at a bottom right part of a projection area TA. However, the first setting UI 1010 may be projected at a top right part, a top left part, or a bottom left part.

The first setting UI 1010 includes a first image G1 and a second image G2. The first image G1 is an image showing the microphone 72. The second image G2 includes setting result information J1 showing the result of a setting of the projector 1 corresponding to a speech-based operation, and operation information J2 showing an operation for projecting the second setting UI 1020 for volume setting. The setting result information J1 shown in FIG. 3 shows that the volume level is set to “15”. The operation information J2 shown in FIG. 3 shows an operation of an “Enter” key on the remote controller 3 or the operation panel 61, as the operation for projecting the second setting UI 1020 for volume setting.

When the projector 1 starts waiting for an input of a sound to the microphone 72, the projection control unit 113 causes the projection unit 80 to project the first image G1. An example of a trigger for the projector 1 to start waiting for an input of a sound may be an operation of a dedicated key provided on the remote controller 3 or the operation panel 61 or the like, or an input of a dedicated wake word, or the like. When a setting result notification is inputted to the projection control unit 113 from the operation control unit 112 during the projection of the first image G1, the projection control unit 113 causes the projection unit 80 to project the first setting UI 1010 in such a way that the second image G2 is added to the first image G1 that is already being projected. Thus, the projection of the first setting UI 1010 enables the user to easily recognize that a setting of the projector 1 is executed by a speech-based operation.

As described above, the first setting UI 1010 includes the setting result information J1 and thus shows that a setting of the projector 1 corresponding to a speech-based operation is executed. Therefore, the first setting UI 1010 need not include various kinds of information for executing a setting of the projector 1 corresponding to a speech-based operation. For example, when the first setting UI 1010 shows that a volume setting is executed, the first setting UI 1010 need not include various kinds of information about the volume setting such as a range of volume level that can be set or an interface of the interface unit 20 with which a volume level can be set. Thus, the projection control unit 113 can project the first setting UI 1010 occupying as small an area as possible in the projection area TA. This restrains a drop in the visibility of the image supplied from the image supply device 2 and also enables the user to recognize that a setting of the projector 1 is executed by a speech-based operation.

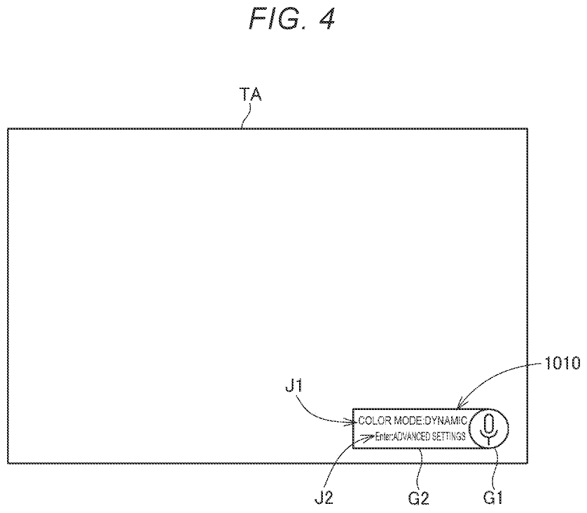

FIG. 4 shows an example of the first setting UI 1010, similarly to FIG. 3.

The first setting UI 1010 shown in FIG. 4 shows that the color mode is set to the dynamic mode by a speech-based operation.

The first setting UI 1010 shown in FIG. 4 includes a first image G1 and a second image G2, similarly to the first setting UI 1010 shown in FIG. 3. The second image G2 shown in FIG. 4 includes setting result information J1 and operation information J2, similarly to the second image G2 shown in FIG. 3. The setting result information J1 shown in FIG. 4 shows that the color mode is set to the dynamic mode. The operation information J2 shown in FIG. 4 shows an operation of the “Enter” key on the remote controller 3 or the operation panel 61 or the like, as the operation for projecting the second setting UI 1020 for color mode setting.

In this way, the first setting UI 1010 is projected in the same layout even when the target of setting of the projector 1 is different. Therefore, the area occupied by the first setting UI 1010 in the projection area TA does not change depending on the target of setting of the projector 1. Thus, the projector 1 can restrain a drop in the visibility of the image supplied from the image supply device 2 and can also project the first setting UI 1010 readily visible to the user.

In FIGS. 3 and 4, the operation information J2 shows an operation of the “Enter” key on the remote controller 3 or the operation panel 61. However, the operations represented by the operation information J2 shown in FIGS. 3 and 4 are simply examples. The operation represented by the operation information J2 is not limited to an operation of the “Enter” key on the remote controller 3 or the operation panel 61 and may be any single operation.

Back to the description of the flowchart in FIG. 2, when the projection control unit 113 causes the projection unit 80 to project the first setting UI 1010, the operation control unit 112 determines whether operation data corresponding to the operation represented by the operation information J2 is inputted from the input processing unit 63 or not (step SA8). In the cases of FIGS. 3 and 4, the operation control unit 112 in step SA8 determines whether operation data representing an operation of the “Enter” key is inputted from the input processing unit 63 or not.

When the operation control unit 112 determines that operation data corresponding to the operation represented by the operation information J2 is not inputted from the input processing unit 63 (NO in step SA8), the projection control unit 113 determines whether a predetermined time has passed since the projection of the first setting UI 1010 is started, or not (step SA9).

When it is determined that a predetermined time has not passed since the first setting UI 1010 is projected (NO in step SA9), the projection control unit 113 returns the processing to step SA8.

Meanwhile, when it is determined that a predetermined time has passed since the first setting UI 1010 is projected (YES in step SA8), the projection control unit 113 stops the projection unit 80 from projecting the first setting UI 1010 (step SA10).

Thus, continuous projection of the first setting UI 1010 for an unnecessarily long period despite no operation made by the user can be avoided, and a drop in the visibility of the image supplied from the image supply device 2 due to the projection of the first setting UI 1010 can be restrained.

Back to the description of step SA8, when it is determined that operation data corresponding to the operation represented by the operation information J2 is inputted from the input processing unit 63 (YES in step SA8), the operation control unit 112 shifts the operation mode from the first operation mode to the second operation mode (step SA11).

Next, the projection control unit 113 causes the projection unit 80 to project the second setting UI 1020 (step SA12). When the processing reaches step SA12 via steps SA7, SA8, and SA11, the projection control unit 113 causes the projection unit 80 to project the second setting UI 1020 for the same target of setting as the target of setting of the projector 1 shown by the first setting UI 1010 projected in step SA7.

For example, when the remote controller 3 or the operation panel 61 accepts an operation of the “Enter” key while the first setting UI 1010 shown in FIG. 3 is being projected, the projection control unit 113 causes the projection unit 80 to project the second setting UI 1020 for the volume.

Also, for example, when the remote controller 3 or the operation panel 61 accepts an operation of the “Enter” key while the first setting UI 1010 shown in FIG. 4 is being projected, the projection control unit 113 causes the projection unit 80 to project the second setting UI 1020 for the color mode.

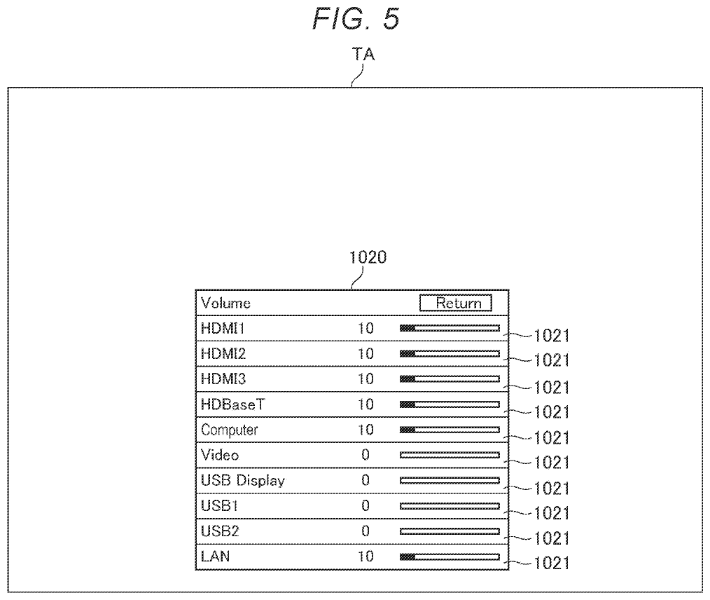

FIG. 5 shows an example of the second setting UI 1020.

The second setting UI 1020 shown in FIG. 5 is the second setting UI 1020 for the volume. In FIG. 5, the second setting UI 1020 is projected at bottom center part of the projection area TA. However, the position where the second setting UI 1020 is projected is not limited to the bottom center part.

The second setting UI 1020 shown in FIG. 5 includes a plurality of setting items 1021. The setting items 1021 are items for setting the volume level of image data supplied to the interface of the interface unit 20. The second setting UI 1020 includes the setting items 1021 corresponding to the number of interfaces of the interface unit 20. One setting item 1021 represents the name of an interface, the currently set volume level, and the relationship between the current volume level and the range of volume level that can be set.

The user selects operates the remote controller 3 or the operation panel 61 to select one setting item 1021, then operates the remote controller 3 or the operation panel 61 in the state where the one setting item 1021 is selected, and thus can set the volume of the image data supplied from the image supply device 2 to a desired volume for each interface.

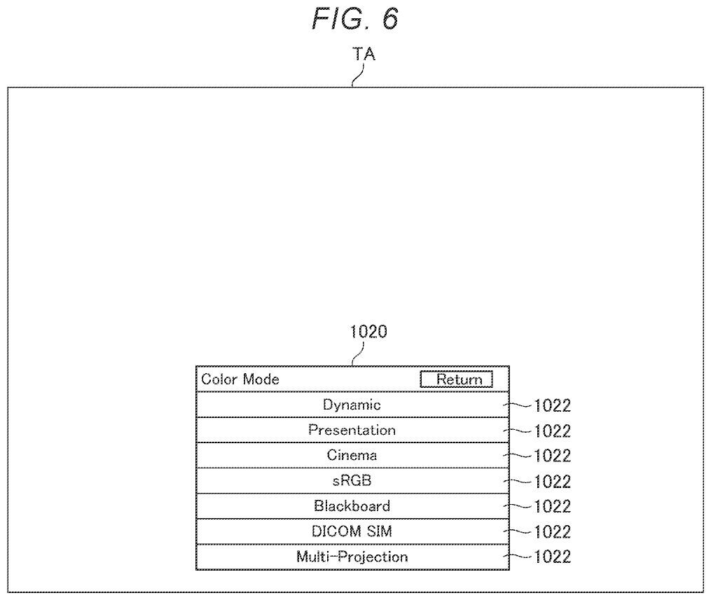

FIG. 6 shows an example of the second setting UI 1020.

The second setting UI 1020 shown in FIG. 6 includes a plurality of selection items 1022. The selection items 1022 are items for selecting a color mode. The second setting UI 1020 includes the selection items 1022 corresponding to respective color modes that can be set.

The user operate the remote controller 3 or the operation panel 61 to select one selection item 1022 on the second setting UI 1020 and thus can set the color mode to a desired color mode.

When the processing shifts via steps SA7, SA8, and SA11, the second setting UI 1020 shown in FIG. 5 or 6 is switched from the first setting UI 1010. However, when the processing does not shift via steps SA7, SA8, and SA11, the user operates the remote controller 3 or the operation panel 61 to move up and down the screen hierarchy, thus causing the second setting UI 1020 to be projected.

As described above, while the second setting UI 1020 is being displayed in the second operation mode, the operation control unit 112 does not execute a setting of the projector 1 corresponding to a speech-based operation accepted by the microphone 72. Thus, when a setting of the projector 1 is being executed by a non-speech-based operation, a setting of the projector 1 that is not intended by the user is not executed based on a speech. Also, since the operation control unit 112 does not execute a setting of the projector 1 based on a speech when a setting of the projector 1 is being executed by a non-speech-based operation, the operation control unit 112 outputs no setting result notification to the projection control unit 113. That is, the projector 1 does not switch the user interface from the second setting UI 1020 to the first setting UI 1010 based on a speech, while the user is setting the projector 1 by a non-speech-based operation. Thus, when the user is setting the projector 1 by a non-speech-based operation, a setting of the projector 1 that is not intended by the user can be prevented from being executed based on a speech, and the content of projection can be prevented from being changed to a content that is not intended by the user, based on a speech.

Back to the description of the flowchart shown in FIG. 2, the operation control unit 112 determines whether or not to end the projection of the second setting UI 1020, based on operation data inputted from the input processing unit 63 (step SA13).

When the operation control unit 112 determines that the projection of the second setting UI 1020 is not to end (NO in step SA13), the projection control unit 113 returns the processing to step SA12 and continues projecting the second setting UI 1020.

Meanwhile, when the operation control unit 112 determines that the projection of the second setting UI 1020 is to end (YES in step SA13), the projection control unit 113 ends the projection of the second setting UI 1020 (step SA14).

Back to the description of step SA6, when it is determined that the notification inputted from the operation control unit 112 is a second operation mode notification (second operation mode notification in step SA6), the projection control unit 113 causes the projection unit 80 to project the second setting UI 1020 (step SA12). When the processing does not shift via steps SA7, SA8, and SA11, the projection control unit 113 causes the projection unit 80 to project the second setting UI 1020 corresponding to a non-speech-based operation. That is, when the processing does not shift via steps SA7, SA8, and SA11, the projection control unit 113 causes the projection unit 80 to project the second setting UI 1020 corresponding to a user operation on the remote controller 3 or the operation panel 61.

Next, the operation control unit 112 executes the processing in step SA13 and the projection control unit 113 executes the processing in step SA14.

As described above, in the control method for the projector 1, when the microphone 72 accepts a speech-based operation, the first operation mode is executed, and the first setting UI 1010 showing that the setting of the projector 1 corresponding to the speech-based operation is executed is displayed. When the remote control light receiving unit 62 or the operation panel 61 accepts a non-speech-based operation, the second operation mode is executed, and the second setting UI 1020 for executing the setting of the projector 1 corresponding to the non-speech-based operation is displayed. While the second setting UI 1020 is being displayed, the setting of the projector 1 corresponding to the speech-based operation accepted by the microphone 72 is not executed.

The projector 1 has the projection unit 80, the microphone 72 accepting a speech-based operation, the remote control light receiving unit 62 or the operation panel 61 accepting a non-speech-based operation, and the control unit 10 executing the first operation mode when the microphone 72 accepts a speech-based operation, and causing the projection unit 80 to project the first setting UI 1010 showing that the setting of the projector 1 corresponding to the speech-based operation is executed, the control unit 10 executing the second operation mode when the remote control light receiving unit 62 or the operation panel 61 accepts a non-speech-based operation, and causing the projection unit 80 to project the second setting UI 1020 for executing the setting of the projector 1 corresponding to the non-speech-based operation. The control unit 10 does not execute the setting of the projector 1 corresponding to the speech-based operation accepted by the microphone 72 while the second setting UI 1020 is being displayed.

In the control method for the projector 1 and the projector 1, a setting of the projector 1 corresponding to a speech-based operation is not executed while the second setting UI 1020 is being displayed. Therefore, a setting of the projector 1 corresponding to a speech-based operation is not executed during an operation that is not a speech-based operation. Also, in the control method for the projector 1 and the projector 1, since a setting of the projector 1 corresponding to a speech-based operation is not executed while the second setting UI 1020 is being displayed, the user interface is not switched from the second setting UI 1020 to the first setting UI 1010 during an operation that is not a speech-based operation. Therefore, in the control method for the projector 1 and the projector 1, during an operation that is not a speech-based operation, a setting of the projector 1 that is not intended by the user can be prevented from being executed based on a speech, and the content of projection can be prevented from being changed to a content that is not intended by the user. Thus, a speech-based operation and a non-speech-based operation can be enabled in the projector 1.

In the control method for the projector 1, when the remote control light receiving unit 62 or the operation panel 61 accepts a non-speech-based operation during the execution of the first operation mode, the operation mode shifts to the second operation mode and the user interface that is displayed is switched from the first setting UI 1010 to the second setting UI 1020.

According to this configuration, when a non-speech-based operation is accepted during the execution of the first operation mode, the operation mode shifts to the second operation mode and the user interface is switched from the first setting UI 1010 to the second setting UI 1020. Therefore, a setting of the projector 1 by a non-speech-based operation can be performed after the projector 1 is set by a speech-based operation. Thus, for example, in cases such as when a setting by a speech-based operation is in sufficient or when the user wants to make advanced settings after a speech-based operation, the user can easily set the projector 1 by a non-speech-based operation.

### Second Embodiment

A second embodiment will now be described.

In the second embodiment, the operation control unit 112 also has a third operation mode, as its operation mode.

The third operation mode is an operation mode where a setting of the projector 1 corresponding to a speech-based operation and a setting of the projector 1 corresponding to a non-speech-based operation can be executed when the remote control light receiving unit 62 or the operation panel 61 accepts a specified operation in the second operation mode.

For example, when a key enabling a speech-based operation is operated on the remote controller 3 or the operation panel 61, the operation control unit 112 shifts the operation mode from the second operation mode to the third operation mode.

Even when the operation mode shifts from the second operation mode to the third operation mode, the projection control unit 113 projects the second setting UI 1020. Thus, the user can set the projector 1 by a speech-based operation and a non-speech-based operation via the second setting UI 1020. Of the operations via the second setting UI 1020, in some cases, a speech-based operation can be performed more swiftly than an operation via the remote controller 3 or the operation panel 61, for example, in the case of input of a letter, selection of an item, or the like. The second embodiment can increase user-friendliness in such cases. In the third operation mode, which is a different operation mode from the first operation mode, the first setting UI 1010 is not projected. Therefore, the setting UI 1000 projected by a speech-based operation is not switched from the second setting UI 1020 to the first setting UI 1010.

As described above, in the second embodiment, when the remote control light receiving unit 62 or the operation panel 61 accepts a specified operation while the second setting UI 1020 is being displayed, the operation mode shifts to the third operation mode, where a setting of the projector 1 corresponding to a speech-based operation accepted by the microphone 72 and a setting of the projector 1 corresponding to a non-speech-based operation accepted by the remote control light receiving unit 62 or the operation panel 61 can be executed.

This configuration enables the projector 1 to be set by a speech-based operation and a non-speech-based operation and therefore increases user-friendliness in the setting of the projector 1. Also, since the operation mode shifts to the third operation mode instead of the first operation mode when a specified operation is performed, the content of projection is not changed by a speech-based operation. Therefore, the projector 1 according to the second embodiment enables a speech-based operation and a non-speech-based operation in the projector 1 and also improves user-friendliness.

The foregoing embodiments are preferred embodiments of the present disclosure. However, the present disclosure is not limited to the foregoing embodiments and can be carried out with various modifications without departing from the spirit and scope of the present disclosure.

For example, in embodiments, the setting of the projector 1 corresponding to a speech-based operation and a non-speech-based operation is described as an example of the processing corresponding to a speech-based operation and a non-speech-based operation. However, the processing corresponding to a speech-based operation and a non-speech-based operation is not limited to the setting of the projector 1 and may be other types of processing of the projector 1 than the setting.

For example, in the embodiments, the projector 1 is configured to perform speech recognition processing of analyzing a digital signal of a speech picked up by the microphone 72 and forming a text of the speech picked up by the microphone 72. However, an external device that can communicate with the projector 1 may perform the speech recognition processing. For example, when the projector 1 is coupled to a local network, a host device coupled to this local network may perform the speech recognition processing. When the projector 1 is coupled to a global network, a server device coupled to this global network may perform the speech recognition processing. In this case, the projector 1 transmits a digital signal of a speech picked up by the microphone 72 to the external device and receives speech text data from the external device. In this case, the control unit 10 of the projector 1 may not function as the speech analysis unit 111, and the storage unit 120 may not store the speech dictionary data 123.

Also, for example, in the foregoing embodiments, the projector 1 has the microphone 72. However, an external device such as the remote controller 3 may have the microphone 72, and the projector 1 may be configured without having the microphone 72. In this case, the projector 1 has a functional unit receiving audio data representing a speech picked up by the microphone 72, from the external device having the microphone 72. In the case of this configuration, this functional unit is equivalent to the first acceptance unit.

The foregoing control method for the projector 1 may be implemented using a computer provided in the projector 1 or using an external device coupled to the projector 1. In this case, the present disclosure can be configured in the form of a program executed by a computer to implement the method, a recording medium in which this program is recorded in a computer-readable manner, or a transmission medium transmitting this program.

For example, each functional unit of the projector 1 shown in FIG. 1 represents a functional configuration and is not particularly limited to a specific form of installation. That is, pieces of hardware corresponding to the individual functional units need not be installed. A single processor may execute a program to implement a plurality of functional units. Also, a part of the functions implemented by software in the embodiments may be implemented by hardware, and a part of the functions implemented by hardware may be implemented by software. Moreover, the specific and detailed configuration of each of the other parts of the projector 1 can be altered arbitrarily without departing from the spirit and scope of the present disclosure.

The processing steps in the flowchart shown in FIG. 2 are formed by dividing the processing of the projector 1 according to the main processing content in order to facilitate understanding of the processing of the projector 1. The present disclosure is not limited by the way the processing is divided into processing steps and how each processing step is called in the flowchart of FIG. 2. The processing of the projector 1 can also be divided into more processing steps according to the processing content, and one processing step can be divided to include more processing. The order of processing in the flowchart is not limited to the illustrated example, either.

The display device according to the present disclosure is not limited to the projector 1 projecting an image onto the screen SC. For example, the display device includes a self-light-emitting-type display device such as a monitor or a liquid crystal television, for example, a liquid crystal display device displaying an image on a liquid crystal display panel or a display device displaying an image on an organic EL panel.

What is claimed is:

1. A control method for a display device that includes a first acceptance unit accepting a first operation based on a speech and a second acceptance unit accepting a second operation based on a non-speech measure, the control method comprising:
executing a first operation mode when the first acceptance unit accepts the first operation, and displaying a first user interface showing that processing corresponding to the first operation is executed;
executing a second operation mode when the second acceptance unit accepts the second operation, and displaying a second user interface that can be operated by the second operation accepted by the second acceptance unit; and
not executing the processing corresponding to the first operation accepted by the first acceptance unit, while displaying the second user interface.

2. The control method for the display device according to claim 1, wherein
when the second acceptance unit accepts the second operation while the first operation mode is being executed, a shift to the second operation mode is made and a user interface that is displayed is switched from the first user interface to the second user interface.

3. The control method for the display device according to claim 1, wherein
when the second acceptance unit accepts a specified operation while the second user interface is being displayed, a shift to a third operation mode is made in which processing corresponding to the first operation accepted by the first acceptance unit and processing corresponding to the second operation accepted by the second acceptance unit can be executed.

4. A display device comprising:
a display unit;
a first acceptance unit accepting a first operation based on a speech;
a second acceptance unit accepting a second operation based on a non-speech measure; and
a control unit executing a first operation mode when the first acceptance unit accepts the first operation, and displaying a first user interface showing that processing corresponding to the first operation is executed, the control unit executing a second operation mode when the second acceptance unit accepts the second operation, and displaying a second user interface that can be operated by the second operation accepted by the second acceptance unit, wherein
the control unit does not execute the processing corresponding to the first operation accepted by the first acceptance unit, while the second user interface is being displayed.
